(19) United States
(12) Patent Application Publication
(10) Pub. No.: US 2010/0080204 A1
(43) Pub. Date: Apr. 1, 2010

(54) WLAN TRANSCEIVING SYSTEM

(76) Inventors: Kuang-Yu Yen, Taichung City (TW); Der-Zheng Liu, Hsinchu County (TW); Ka-Un Chan, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/568,684

(22) Filed: Sep. 29, 2009

Related U.S. Application Data
(60) Provisional application No. 61/101,143, filed on Sep. 29, 2008.

(51) Int. Cl. H04W 4/00

(52) U.S. Cl. 370/338

(57) ABSTRACT

A WLAN transceiving system, which comprises: a plurality of antennas; a plurality of receiving circuits, wherein each one of receiving circuits is coupled to one of the antenna to receive a input signal from the antennas; and a plurality of transmitting circuits, for outputting one of an output signal and an amplified output signal, wherein at least one of the transmitting circuit includes a power amplifier and utilizes at least one of the power amplifier to amplify an output signal to generate the amplified output signal, where a number of the power amplifiers is less than a number of the antennas.

### CROSS REFERENCE TO RELATED APPLICATIONS

This application claims the benefit of U.S. Provisional Application No. 61/101,143, filed on 2008 Sep. 29 and entitled “Unequal Multiple-Antenna Transceiver”, the contents of which are incorporated herein by reference.

### BACKGROUND OF THE INVENTION

1. Field of the Invention

The present invention relates to a WLAN (wireless Local Area Network) transceiving system, and particularly relates to a WLAN transceiving system utilizing an unequal mechanism.

2. Description of the Prior Art

In the field of WLAN communication, a WLAN transceiving system generally includes single antenna or multiple antennas for data transmission. A single-antenna system with one transmitter and one receiver (i.e. 1T1R system) has the lowest cost. However, the throughput performance thereof is lower than that of the multiple antenna systems in the near range. The stability is also unsatisfactory in the middle range due to no MRC (Maximum Ratio Combining) gain, as shown in FIG. 1.

Besides, for a multiple-antenna system (MIMO) with one transmitter and two receivers (i.e. 1T2R system), the throughput performance is better than that of above 1T1R system in middle/long range. However, the throughput is lower than that of a multiple transmitter system in near range, since only one transmitter exists. It is a disadvantage for peer-to-peer communication, especially for high speed file sharing.

Please refer to FIG. 1 again, for a multiple antenna system with two transmitters and two receivers (i.e. 2T2R system), the throughput performance is the best among 1T1R, 1T2R and 2T2R systems in near/middle/long ranges. However, the 2T2R system is the most expensive one. Additionally, it is also difficult to integrate two CMOS PAs (power amplifier) into a SoC chip, because of the higher power consumption and heat dissipation in the smaller IC package. Additionally, power amplifiers occupy a large region (20%˜25% of a transceiving circuit) and consumes a large amount of current (ex. consumes current of 50 mA˜60 mA, when gain of the power amplifiers is 0 dBM).

### SUMMARY OF THE INVENTION

One embodiment of the present invention is to provide a WLAN transceiving system with an unequal mechanism achieved by hardware or software, to decrease cost or meet different requirement.

One embodiment of the present invention discloses a WLAN transceiving system, which comprises: a plurality of antennas; a plurality of receiving circuits, wherein each one of receiving circuits is coupled to one of the antenna to receive a input signal from the antennas; and a plurality of transmitting circuits, for outputting one of an output signal and an amplified output signal, wherein at least one of the transmitting circuit includes a power amplifier and utilizes at least one of the power amplifier to amplify an output signal to generate the amplified output signal, where a number of the power amplifiers is less than a number of the antennas.

Another embodiment of the present invention discloses a WLAN transceiving system, which comprises: a plurality of antennas; a transceiving circuit, and at least one power amplifier. The transceiving circuit comprises: at least one receiver, for receiving at least one input signal from the antennas; and at least one transmitter, for outputting at least one output signal. The power amplifier is coupled between one of the transmitters and one of the antennas, for amplifying the output signal, where a number of the power amplifiers is less than a number of the antennas.

Still another embodiment of the present invention discloses a WLAN transceiving system, which comprises: a plurality of antennas; a plurality of receiving circuits, wherein each one of receiving circuits is coupled to one of the antenna to receive an input signal from the antennas; and a plurality of transmitting circuits, for outputting an amplified output signal, wherein each of the transmitting circuits includes a power amplifier and utilizes part of the power amplifiers as operating power amplifiers to amplify an output signal to generate the amplified output signal.

Another embodiment of the present invention discloses a WLAN transceiving system, which comprises: a plurality of antennas; a transceiving circuit, and at least one power amplifier. The transceiving circuit comprises: at least one receiver, for receiving at least one input signal from the antennas; and at least one transmitter, for outputting at least one output signal. The power amplifier is coupled between one of the transmitters and one of the antennas, wherein part of the power amplifiers are utilized operating power amplifiers for amplifying the output signal.

The above-mentioned embodiments can be utilized for a WLAN communication system following the spec: giga bit WLAN, 802.11 AC, AD, but not limited. Via above-mentioned embodiments, the numbers of power amplifiers can be saved, such that the occupied region and cost of power amplifiers can decrease. Besides, different communication specification can be utilized to meet various requirements.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating the relation between throughput and attenuation of WLAN communication systems for different types.

FIG. 2 is a block diagram illustrating a WLAN transceiving system according to an embodiment of the present application.

FIG. 3 is a schematic diagram illustrating the comparing result of the relation of throughput and attenuation, between the WLAN communication system of the embodiment shown in FIG. 2 and prior art WLAN communication systems.

FIG. 4(a) and FIG. 4(b) are block diagrams illustrating WLAN transceiving systems according to embodiments of the present application.

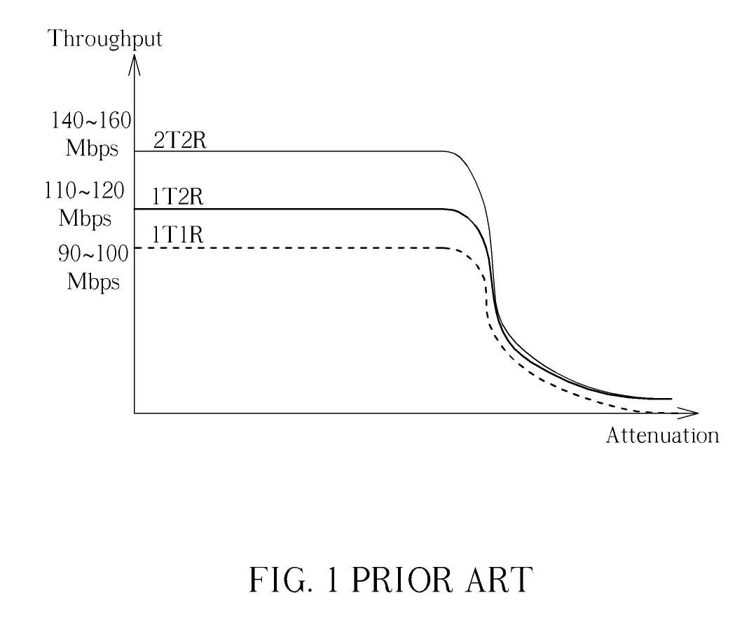

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

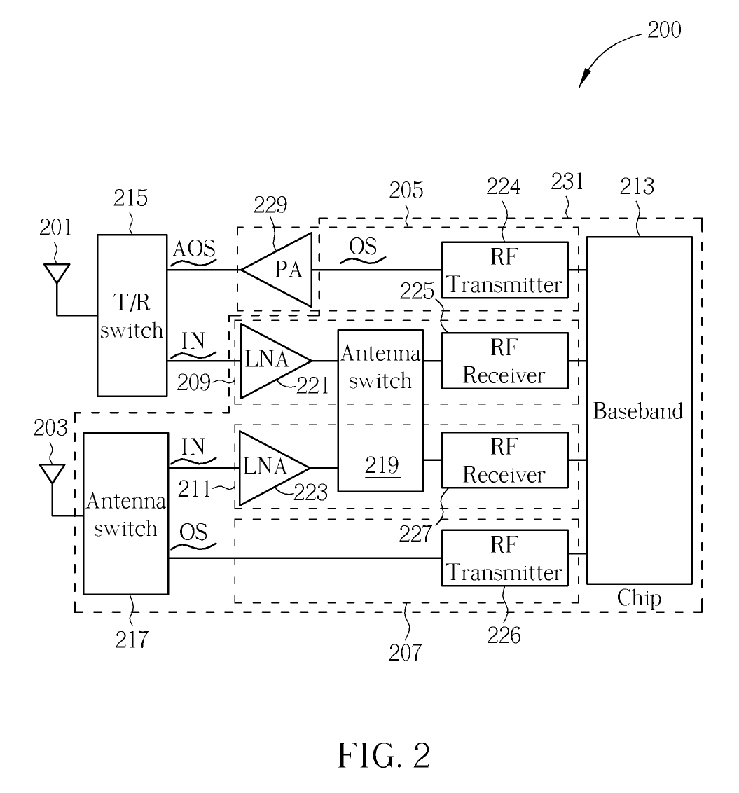

FIG. 2 is a block diagram illustrating a WLAN transceiving system 200 according to an embodiment of the present application. As shown in FIG. 2, the WLAN transceiving system 200 includes antennas 201, 203, transmitting circuits 205, 207, receiving circuits 209, 211 and a baseband circuit 213. In this embodiment, the receiving circuits 209, 211 not only include RF receivers 225 and 227 but also include low noise amplifiers 221 and 223 to amplify input signals IN. However, the low noise amplifiers 221 and 223 can be removed if the input signals IN are strong enough or due to other considerations. The transmitting circuits 205, 207 respectively include RF transmitters 224 and 226 to output the output signals OS, but only the transmitting circuit 205 includes the power amplifier 229 for amplifying the output signal OS to generate the amplified output signal AOS. Such structure is named an unsymmetrical mechanism, which can be achieved via software or hardware. The embodiment shown in FIG. 2 discloses an unsymmetrical mechanism achieved via hardware. Besides, a PA driver can (not shown) be provided in the transmitter (ex. in a mixer of the transmitter) to provide driving current to the power amplifier.

Accordingly, the transmitting circuit 207 can be utilized when a strong output signal OS is not necessary (ex. for a short distance communication), and the transmitting circuit 205 can be utilized when a stronger output signal AOS is needed (ex. for a long distance communication). In this case, the WLAN transceiving system 200 can further include a controller (not shown) to control which transmitting circuit should operate. By this way, the number of power amplifiers can be saved. Thus the circuit area and power consumption due to power amplifiers can decrease as well. Besides, the transmitting circuits 205 and 207 can utilize different signal communication specifications. For example, the transmitting circuit 205 can follow OFDMA specification, and the transmitting circuit 207 can follow MIMO specification. By this way, loose signal communication specification can be utilized and different end user requirements can be met.

Moreover, the WLAN transceiving system 200 can further include T/R switches 215 and 217 to perform a switch operation between the transmitting circuit 205 and the receiving circuit 209, and a switch operation between the transmitting circuit 207 and the receiving circuit 211. Additionally, the WLAN transceiving system 200 can further include an antenna switch 219 to switch the receiving circuits 209, 211 to different antennas. However, the T/R switches 215, 217 and the antenna switch 219 can also be removed from the WLAN transceiving system.

The main concept that the embodiment shown in FIG. 2 represents is: the number of the power amplifiers for transmitters is less than the number of antennas, such that the transmitters can be controlled to utilize the power amplifiers to amplify the signals to be output or not, depending whether a stronger output signal is needed. In other words, the power consumption of transmitting circuit 205 and the power consumption of transmitting circuit 207 are designed to be different when data transmission so that the whole system 200 has more flexibility in power control. Please note the structure of the WLAN transceiving system 200 is only for example and does not mean to limit the scope of the present application. Moreover, the numbers of antennas, transmitting circuits and receiving circuits are not limited to two, and the number of the power amplifier is not limited to one. Additionally, the transmitting circuit 207, the receiving circuits 209, 211, the baseband circuit 213, and the RF transmitter 224 can be integrated a chip 231 (or regarded as an transceiving circuit). In this case, the power amplifier 229 can be regarded as an external power amplifier.

On the other hand, low noise amplifiers 221 and 223 can also be designed as an unsymmetrical architecture or mechanism. For example, low noise amplifier 223 has lower power consumption than low noise amplifier 221, the WLAN transceiving system 200 can select antenna 203 to receive data when the transmission signal is strong (ex. for a short distance communication). Contrarily, the WLAN transceiving system 200 can select antenna 201 to receive data when the transmission signal is weak (ex. for a long distance communication). The architecture of unsymmetrical low noise amplifiers 221 and 223 can get the advantage of power controlling flexibility as the unsymmetrical the transmitting circuits 205 and 207 mentioned above.

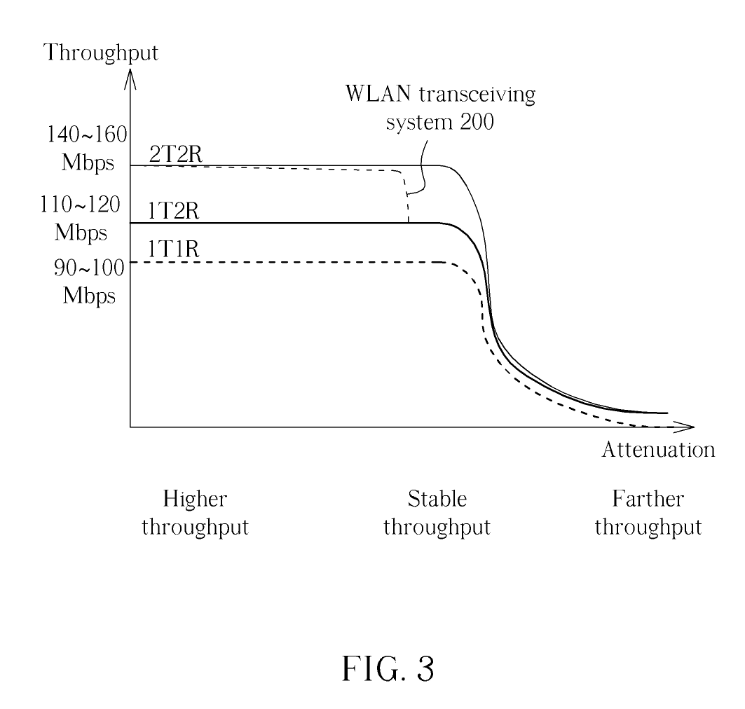

FIG. 3 is a schematic diagram illustrating the comparing result of the relation for throughput and attenuation, between the WLAN communication system of the embodiment shown in FIG. 2 and prior art WLAN communication systems. As shown in FIG. 3, in near range for the wireless PAN (WPAN) application, the throughput is higher with multiple antennas. In middle range, the stability is good with MRC gain. The transmission range is also longer by using switched antenna diversity.

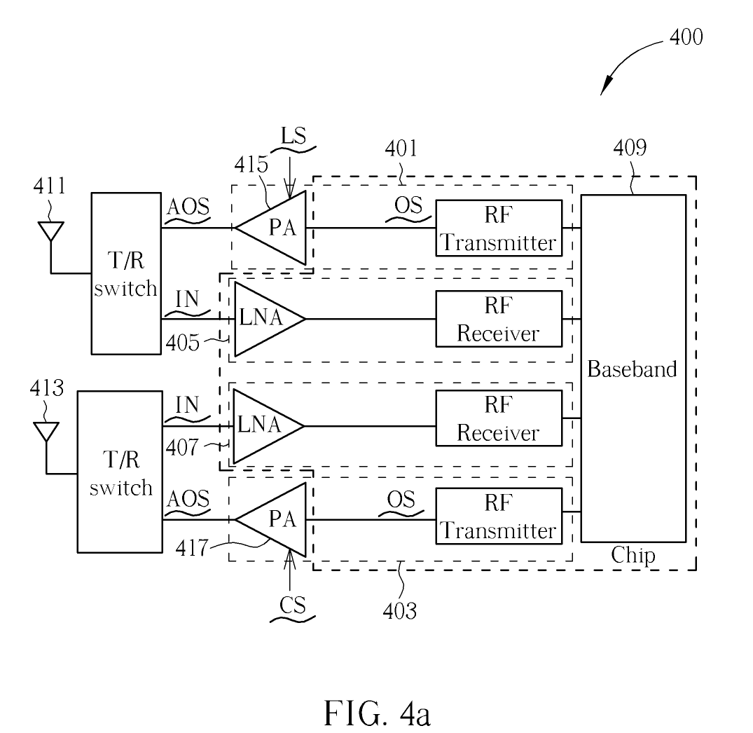

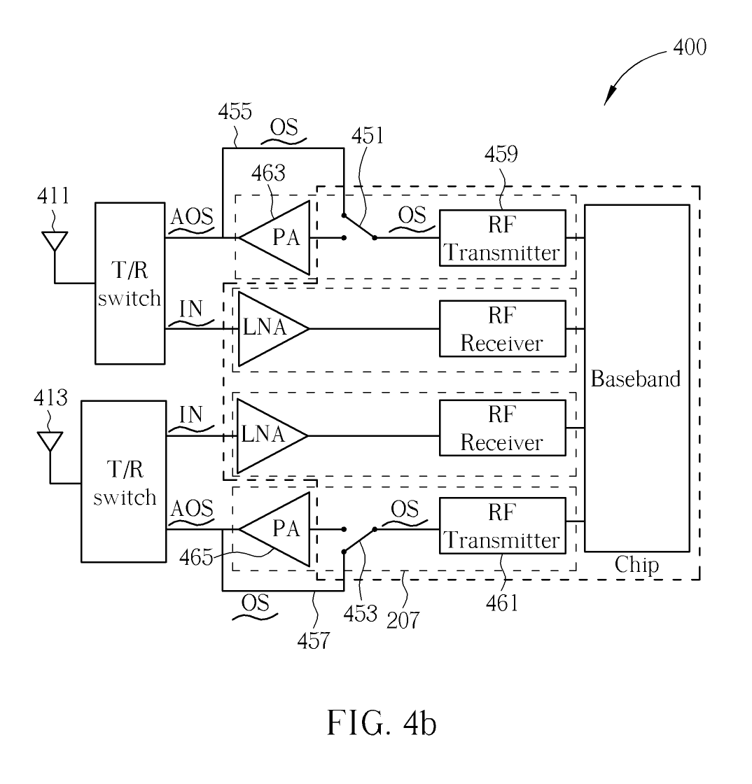

FIGS. 4(a) and 4(b) are block diagrams illustrating WLAN transceiving systems 400 and 450 according to another embodiment of the present application. For brevity, some reference numerals in FIGS. 4(a) and 4(b) are omitted for sake of brevity.

Please refer to FIG. 4(a), comparing with the WLAN transceiving system 200, the unsymmetrical mechanism of the WLAN transceiving system 400 is achieved via hardware and the unsymmetrical mechanism of the WLAN transceiving system 400 can be achieved via software. The WLAN transceiving system 400 includes transmitting circuits 401, 403, receiving circuits 405, 407, a baseband circuit 409 and antennas 411, 413. In this embodiment, both the transmitting circuits 401, 403 include power amplifiers 415, 417. However, power amplifiers 415, 417 can be controlled by control signals CS, which can be generated from a controller (not illustrated), to be enabled or disabled. In this case, the power amplifier is named an operating power amplifier when it is enabled. Accordingly, when anyone of the transmitting circuits 401, 403 does not need the power amplifier to amplify the output signal, the power amplifier can be disabled, if both the power amplifiers are initially enabled. Alternatively, when anyone of the transmitting circuits 401, 403 needs the power amplifier to amplify the output signal, the power amplifier can be enabled, if both the power amplifiers are initially disabled. In other words, the WLAN transceiving system 400 achieves the unsymmetrical mechanism via software. Other characteristics are disclosed in above mentioned description, thus it is omitted for brevity here.

The WLAN transceiving system 450 has similar elements and structure with which of the WLAN transceiving system 400. One of the differences is that the WLAN transceiving system 450 further includes switches 451, 453, and passing by paths 455, 457. If anyone of the output signals OS from the RF transmitters 459, 461 is needed to be amplified, the switches 451, 453 will switch the path to the power amplifier 463 465, such that the output signal OS can be amplified to an amplified output signal AOS. Alternatively, if the output signal OS from the RF transmitters 459, 461 need no amplifying, the switches will switch the path to paths 455, 457, such that the output signal OS can be directly output. In other words, the WLAN transceiving system 450 also achieves the unsymmetrical mechanism via software. The embodiment disclosed in FIG. 2 can also utilize the unsymmetrical mechanism disclosed in FIG. 4. That is, it is not limited that the embodiment disclosed in FIG. 2 must utilize all the power amplifiers. The embodiment disclosed in FIG. 2 can utilize only part of the power amplifiers, the same as the embodiment shown in FIG. 4. Similarly, other characteristics are disclosed in above mentioned description, thus it is omitted for brevity here.

The above-mentioned embodiments can be utilized for a WLAN communication system following the spec: giga bit WLAN, 802.11 AC, AD, but not limited. Via above-mentioned embodiments, the numbers of PA or LNA can be saved, such that the occupied region and cost of power amplifiers can decrease. Besides, different communication specification can be utilized to meet various requirements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A WLAN transceiving system, comprising:
a plurality of antennas;
a plurality of receiving circuits, wherein each one of receiving circuits is coupled to one of the antenna to receive a input signal; and
a plurality of transmitting circuits, for outputting one of an output signal and an amplified output signal;
wherein at least one of the transmitting circuit includes a power amplifier and utilizes at least one of the power amplifier to amplify an output signal to generate the amplified output signal, where a number of the power amplifiers is less than a number of the antennas.

2. The WLAN transceiving system of claim 1, wherein numbers of the antennas, the receiving circuits, and the transmitting circuits are the same.

3. The WLAN transceiving system of claim 1, wherein the transmitting circuit utilizes part of the power amplifiers as operating power amplifiers to amplify an output signal to generate the amplified output signal.

4. The WLAN transceiving system of claim 3, wherein the power amplifiers are initially disabled and least one of the power amplifier is enabled to be the operating power amplifier when the transmitting circuit outputs the amplified output signal.

5. The WLAN transceiving system of claim 3, wherein the transmitting circuits passes by the power amplifiers that are not operating power amplifiers when the transmitting circuit outputs the output signal.

6. The WLAN transceiving system of claim 1, wherein the transmitting circuit including the power amplifier follows a first signal communication specification, where the transmitting circuit including no power amplifier follows a second signal communication specification.

7. A WLAN transceiving system, comprising:
a plurality of antennas;
a plurality of receiving circuits, wherein each one of receiving circuits is coupled to one of the antenna to receive an input signal; and
a plurality of transmitting circuits, for outputting an amplified output signal, wherein each of the transmitting circuits includes a power amplifier and utilizes part of the power amplifiers as operating power amplifiers to amplify an output signal to generate the amplified output signal.

8. The WLAN transceiving system of claim 7, wherein numbers of the antennas, the receiving circuits, the transmitting circuits and the power amplifiers are the same.

9. The WLAN transceiving system of claim 7, wherein the power amplifiers are initially disabled and at least one of the power amplifiers is enabled to be the operating power amplifier when the transmitting circuit outputs the amplified output signal.

10. The WLAN transceiving system of claim 7, wherein the transmitting circuits passes by the power amplifiers that are not operating power amplifiers when the transmitting circuit outputs the output signal.

11. The WLAN transceiving system of claim 7, wherein the transmitting circuit utilizing the operating power amplifier follows a first signal communication specification, where the transmitting circuit does not utilize the power amplifier follows a second signal communication specification.

12. A WLAN transceiving system, comprising:
a first antenna, for receiving a first input signal or transmitting a first output signal;
a second antenna, for receiving a second input signal or transmitting a second output signal;
a first transmitting circuit, for generating the first output signal to the first antenna; and
a second transmitting circuit, for generating the second output signal to the second antenna;
wherein the first transmitting circuit and the second transmitting circuit are unsymmetrical.

13. The WLAN transceiving system of claim 12, wherein the first transmitting circuit includes a power amplifier; and the second transmitting circuit includes no power amplifier.

14. The WLAN transceiving system of claim 12, wherein the power consumption of the first transmitting circuit are different from the power consumption of the second transmitting circuit when data is transmitting.

15. The WLAN transceiving system of claim 12, comprising:
a first receiving circuit, for receiving the first input signal from the first antenna; and
a second receiving circuit, for receiving the second input signal from the second antenna;
wherein the first receiving circuit and the second receiving circuit are unsymmetrical.

16. The WLAN transceiving system of claim 15, wherein the first receiving circuit includes a low noise amplifier; and the second receiving circuit includes no low noise amplifier.
